(19) United States
(12) Patent Application Publication
(10) Pub. No.: US 2026/0132910 A1
(43) Pub. Date: May 14, 2026

(54) ROTATABLE LIGHT-EMITTING ORNAMENT

(71) Applicant: Fangfang Lin, Zhejiang Province (CN)

(72) Inventor: Fangfang Lin, Zhejiang Province (CN)

(21) Appl. No.: 19/443,456

(22) Filed: Jan. 8, 2026

Related U.S. Application Data
(63) Continuation-in-part of application No. 18/392,636, filed on Dec. 21, 2023, now Pat. No. 12,520,960.

(30) Foreign Application Priority Data
Dec. 4, 2023 (CN) 202323294532.4

(51) Int. Cl. F21V 14/06; F21V 17/06; F21V 17/16

(52) U.S. Cl. CPC F21V 14/06; F21V 17/06; F21V 17/16

(57) ABSTRACT

A rotatable light-emitting ornament, comprising: a mounting component comprising a housing; a drive disposed in the housing; a rotator rotatably supported by the mounting component, wherein the drive is connected to the rotator to drive the rotator to rotate relative to the mounting component; and a lighting component comprising a light-transmitting decoration and a light source disposed on the mounting component or the rotator. The rotator includes a transmission member configured to receive a driving force from the drive, and a mounting base fixedly connected to the transmission member. The mounting base and the transmission member are independent components manufactured separately. The mounting base is configured to carry the light-transmitting decoration and drive the light-transmitting decoration to rotate synchronously around a rotation axis of the rotator. The light source is configured to illuminate the light-transmitting decoration.

### CROSS-REFERENCE TO RELATED APPLICATION

This application is a Continuation-In-Part application of U.S. patent application Ser. No. 18/392,636, filed on Dec. 21, 2023, which claims priority to Chinese Patent Application No. 202323294532.4, filed Dec. 4, 2023, each of which is entirely incorporated herein by reference.

### TECHNICAL FIELD

The present application relates to the technical field of lighting, and in particular to a rotatable light-emitting ornament.

### BACKGROUND

Light-emitting ornaments are common decorative items in festivals, interior decoration, or commercial displays, such as Christmas tree toppers and holiday ornaments, which use light and shadow effects to enhance the atmosphere. However, most existing light-emitting ornaments focus on static shape displays. Even for ornaments with dynamic effects, their internal structures are often designed to be relatively rigid. Specifically, in traditional structures, the part responsible for receiving internal power (transmission) and the part responsible for supporting external decoration are usually integrally molded or rigidly fixed. This integrated design results in an overly tight connection between the mechanical structure and the external decoration, leading to a lack of flexibility. This makes it difficult to quickly adapt to or replace decorative components of different forms on a universal drive platform, and also increases the limitations of production and assembly. Therefore, a new type of light-emitting ornament with a more rational structural layout and flexible assembly is needed.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A rotatable light-emitting ornament is provided, comprising: a mounting component, wherein the mounting component includes a housing; a drive disposed in the housing; a rotator rotatably supported by the mounting component, wherein the drive is connected to the rotator to drive the rotator to rotate relative to the mounting component; and a lighting component, comprising a light-transmitting decoration and a light source disposed on the mounting component or the rotator; wherein the rotator includes a transmission member configured to receive a driving force from the drive, and a mounting base fixedly connected to the transmission member, wherein the mounting base and the transmission member are independent components manufactured separately, and the mounting base is configured to carry the light-transmitting decoration and drive the light-transmitting decoration to rotate synchronously around a rotation axis of the rotator; and wherein the light source is configured to illuminate the light-transmitting decoration.

The above aspects or examples and advantages, as well as other aspects or examples and advantages, will become apparent from the ensuing description and accompanying drawings.

### BRIEF DESCRIPTION OF DRAWINGS

For exemplification purposes, and not for limitation purposes, aspects, embodiments or examples of the invention are illustrated in the figures of the accompanying drawings, in which:

FIG. 1 shows a schematic diagram of the overall structure of a rotatable light-emitting ornament with a light-transmitting decoration removed according to an embodiment of the present application;

FIG. 2 shows a schematic diagram of the overall structure of a rotatable light-emitting ornament assembled with a star-shaped decoration according to an embodiment of the present application;

FIG. 3 shows a schematic diagram of the overall structure of a rotatable light-emitting ornament assembled with an angel-shaped decoration according to an embodiment of the present application;

FIG. 4 shows a schematic diagram of an exploded structure of a rotatable light-emitting ornament according to an embodiment of the present application;

FIG. 5 shows a schematic structure of a mounting base in a rotator assembly according to an embodiment of the present application;

FIG. 6 shows a schematic structure of a transmission member in a rotator assembly according to an embodiment of the present application;

FIG. 7 shows a schematic diagram of an internal drive mechanism of a rotatable light-emitting ornament with a housing removed according to an embodiment of the present application;

FIG. 8 shows a schematic diagram of a partial optical texture structure of a light-transmitting decoration according to an embodiment of the present application;

FIG. 9 shows a schematic diagram of a stereoscopic structure of a rotatable light-emitting ornament having a bottom auxiliary lighting unit according to an embodiment of the present application;

FIG. 10 shows a schematic diagram of the structure of a rotatable light-emitting ornament where a composite light source cooperates with a light-transmitting decoration according to an embodiment of the present application;

FIG. 11 shows a schematic diagram of the structure of a rotatable light-emitting ornament assembled with a simulation tree-shaped decoration according to an embodiment of the present application;

FIG. 12 shows a schematic diagram of the structure of a rotatable light-emitting ornament having a film projection function according to an embodiment of the present application;

FIG. 13 shows a schematic diagram of the structure of a rotatable light-emitting ornament assembled with a pumpkin-shaped decoration according to an embodiment of the present application;

FIG. 14 shows a schematic diagram of the structure of a rotatable light-emitting ornament assembled with a candle-shaped decoration according to an embodiment of the present application; and

FIG. 15 shows a schematic diagram of the structure of a rotatable light-emitting ornament assembled with a planetary model assembly according to an embodiment of the present application.

### REFERENCE NUMBER

rotatable light-emitting ornament—100
power—10; plug—101; first conductor—102;
drive—20; motor—201; first gear—202;
rotator—30; boss—301; flange—302; buckle—303; first annular wall—304; first annular protrusion—305; second gear—306; first opening—307; second opening—308; clamping opening—309;
mounting hole—310; first fastener—311; first cavity—312; mounting base—313; transmission member—314; convex block—315;
lighting component—40; light source—401; first lighting unit—4011; second lighting unit—4012; third lighting unit—4013; first base—402; decoration—403; light-guiding texture—4031; prism refraction surface—4032; bubble structure—4033; second annular protrusion—404;
mounting component—50; housing—501; second base—502; second fastener—503; third fastener—504; fourth fastener—505; speaker hole—506; support—507; base—5071; second annular wall—508; first threaded hole—509; first slot—510; first bearing—511; second cavity—512;
controller—60; first circuit board—601; second conductor—602; third conductor—603.

### DETAILED DESCRIPTION OF EMBODIMENTS

The present disclosure will be further described in detail below with reference to the drawings. A preferred embodiment is described in the drawings. However, the present disclosure can be implemented in many different forms and is not limited to the embodiments described herein. Rather, these embodiments are provided to provide a thorough understanding of the present disclosure. The specific embodiments are only explanations of the present disclosure, and the embodiments are not intended to limit the present disclosure. Rather, various modifications may be made in the details within the scope and range of equivalents of the claims and without departing from the present disclosure.

The present disclosure will be described in more details below with reference to the accompanying drawings and in conjunction with embodiments. The examples are provided for better illustration of the present disclosure and should not limit the scope of the present disclosure. In practice, technicians skilled in the art might make small modifications and/or variations of the present disclosure without departing from the scope or spirit of the present disclosure. For example, features described in part of one embodiment may be used in another to create a new embodiment. It is therefore desirable that the present disclosure encompass such modifications and/or variations falling within the scope of the appended claims and their equivalents.

In the description of the present disclosure, terms like “longitudinal”, “transverse”, “up”, “down”, “front”, “back”, “left”, “right”, “vertical”, “horizontal”, “top”, “bottom” denote orientation or positional relationships based on those shown in the drawings and are intended for ease of description only, which in no way entails that the present disclosure must be constructed and operated in a particular orientation and therefore cannot be construed as limiting to the present disclosure. Terms like “joint”, “attach” and “set” used in the present disclosure should be understood in a broad sense, for example, may indicate a direct connection or indirect connection through intermediate components; and it may be a wired electrical connection, a radio connection, or a wireless communication signal connection. The exact meanings of the above terms may slightly differ and should be derived from the actual situation by technicians skilled in the art accordingly.

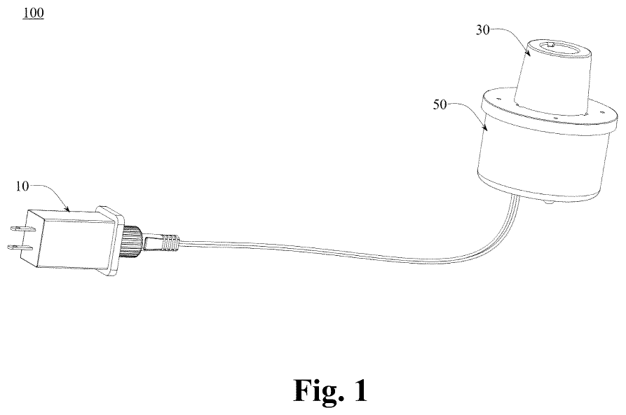

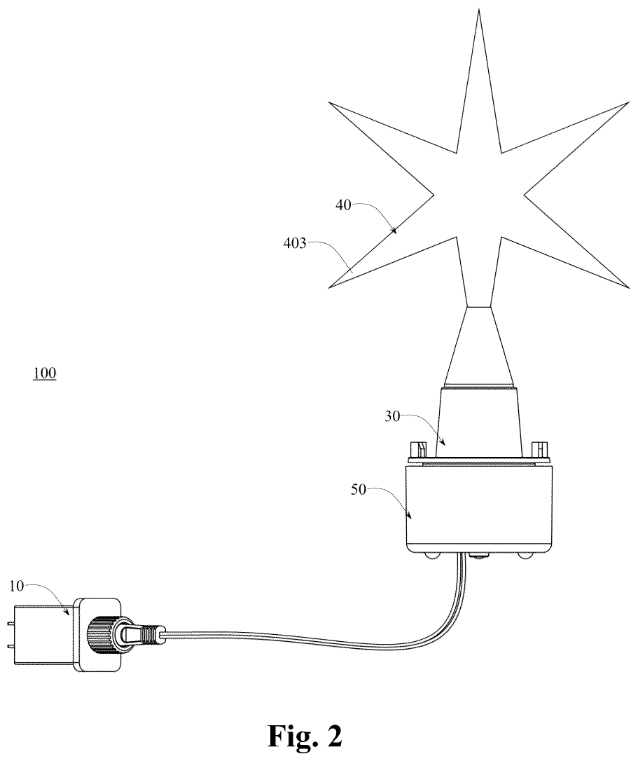

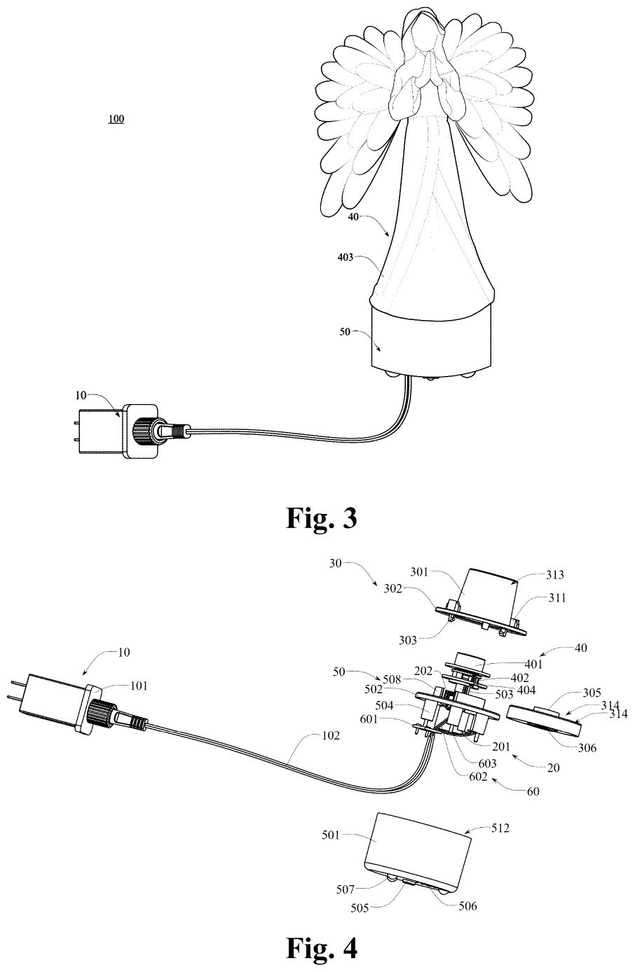

Referring to FIG. 1 to FIG. 4, the present application provides a rotatable light-emitting ornament 100, comprising a rotator 30, a drive 20, a mounting component 50, and a lighting component 40. Both the rotator 30 and the drive 20 are installed on the mounting component 50. The lighting component 40 includes a decoration 403 and a light source 401. The light source 401 is disposed opposite the decoration 403 to illuminate the decoration 403. The decoration 403 is fixedly connected to the rotator 30. The rotator 30 is rotatably connected to the mounting component 50. The drive 20 is connected to the rotator 30 to drive the rotator 30 to rotate, thereby driving the decoration 403 to rotate.

In some embodiments, the rotatable light-emitting ornament 100 is configured as an electromechanical integrated device capable of being installed on a top or side of a support body (such as a tree tip, a column, or other holiday decoration stand of a Christmas tree) and capable of producing a rotating dynamic effect and a light and shadow projection effect.

In this embodiment, the rotatable light-emitting ornament 100 further comprises a power 10. The power 10 comprises a plug 101 and a first conductor 102. The plug 101 connects to an external socket, and the plug 101 is electrically connected to the drive 20 and the lighting component 40 via the first conductor 102 to supply power to the drive 20 and the lighting component 40. It is understandable that, in some embodiments, the power 10 may also include a movable power source such as a battery. In this case, there is no need to provide the plug 101, and the battery directly supplies power to the drive 20 and the lighting component 40 through the first conductor 102.

In some embodiments, to meet the need for the decoration 403 to carry an active light source (such as an LED light or a screen) itself, a conductive slip ring assembly is integrated between the rotator 30 and the mounting component 50. A stator slip ring is installed on the second fastener 503, and a brush in contact with the stator slip ring is installed on the inner side of the rotator 30. After entering the mounting component 50 through the plug 101, external power is transmitted to the rotating rotator 30 via the slip ring. This makes the rotator 30 no longer just a mechanical carrier, but an electrical platform with power supply capability. The interior of the decoration 403 can be installed with complex electronic light-emitting components, or even micro-motors (for local movement of the decoration itself), without worrying about wire entanglement and breakage caused by rotation.

In this embodiment, the drive 20 includes a motor 201 and a first gear 202. The rotator 30 includes a second gear 306. The second gear 306 is fixedly connected to the rotator 30. The motor 201 drives the first gear 202 to rotate, which drives the second gear 306 to rotate, thereby driving the rotator 30 to rotate.

In some embodiments, to reduce noise generated by mechanical transmission and improve user experience in a quiet environment, the drive 20 may also use a belt drive mechanism to replace direct gear engagement. In this embodiment, the drive 20 includes the motor 201, a driving pulley, a driven pulley, and a transmission belt. The driving pulley is fixedly connected to the end of the output shaft of the motor 201. The outer peripheral edge of the bottom of the rotator 30 or the position of the original second gear 306 is replaced by a driven pulley structure having a belt groove. The transmission belt is tensioned between the driving pulley and the driven pulley. Since the transmission belt is usually made of elastic materials such as rubber or polyurethane, its flexible characteristics can effectively absorb high-frequency vibrations generated when the motor 201 runs at high speed, blocking the rigid transmission of vibration energy to the housing 501 and the decoration 403 above. This not only significantly reduces the humming sound during operation of the device but also plays an overload protection role—when external tree branches accidentally jam the decoration 403, the belt will slip on the pulley, thereby preventing the motor 201 from being damaged by overheating due to stalling.

In this embodiment, the rotator 30 further comprises a mounting base 313 and a transmission member 314. The decoration 403 is mounted on the mounting base 313. The mounting base 313 is fixedly connected to the transmission member 314. The second gear 306 is fixedly connected to the transmission member 314. The rotation of the second gear 306 drives the transmission member 314 to rotate, and the rotation of the transmission member 314 drives the mounting base 313 to rotate to drive the decoration 403 to rotate.

In this embodiment, the mounting base 313 further comprises a boss 301 and a flange 302. The flange 302 is fixedly connected to the transmission member 314, and the boss 301 is fixedly connected to the decoration 403. Thus, since the decoration 403 is fixedly connected to the boss 301, the height of the decoration 403 can be increased, thereby meeting the need to place the decoration 403 at a higher position. It is understandable that, in some embodiments, the decoration 403 can also be fixedly connected to the flange 302. The installation position of the decoration 403 can be determined according to the shape, size, and installation method of the decoration 403.

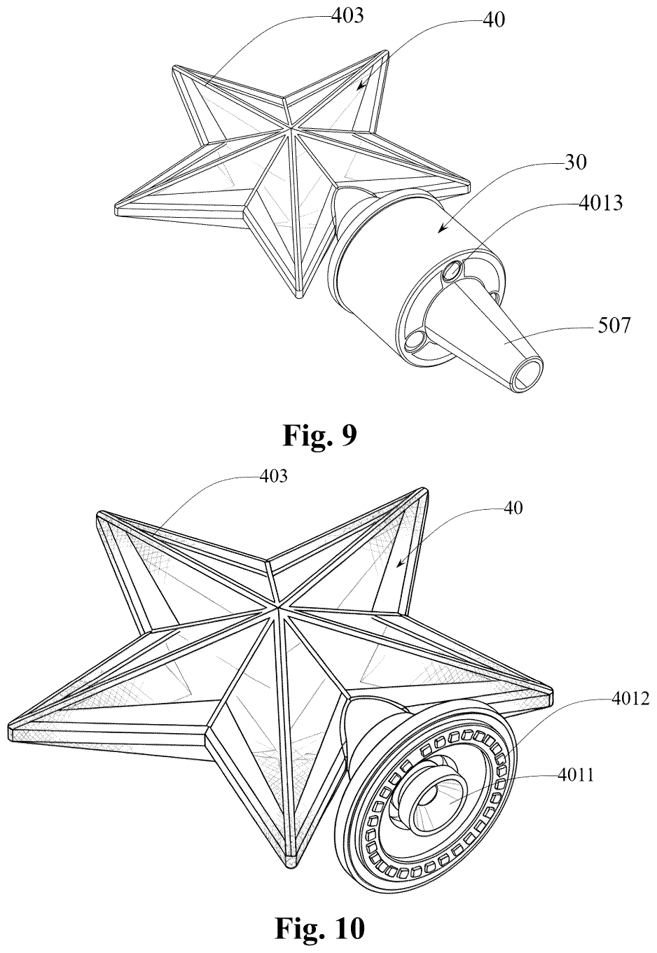

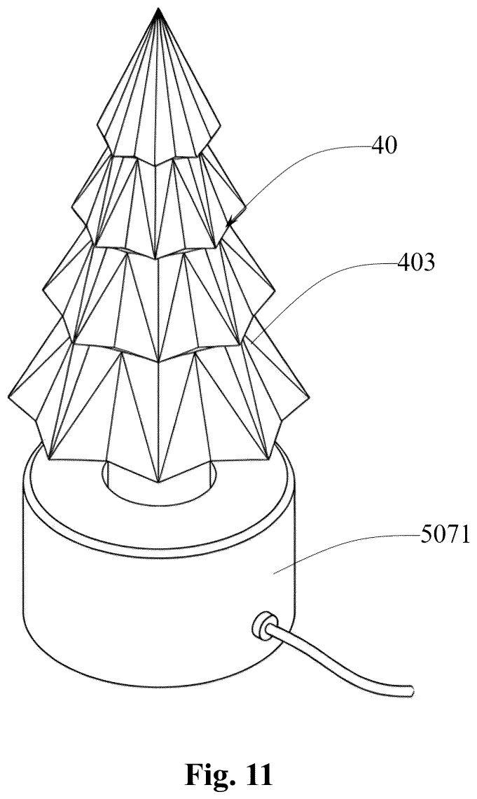

In some embodiments, referring to FIG. 8, when the drive 20 operates to drive the rotator 30 to rotate, the decoration 403 rotates accordingly. Since the position of the light source 401 is fixed, the light beam is projected from the inside onto the inner wall of the continuously rotating decoration 403. If the light-transmitting wall of the decoration 403 is designed with a light-guiding texture 4031 having a gradual thickness change, a prism refraction surface 4032, or an irregular bubble structure 4033, the refraction path and scattering angle of light when passing through the medium will change continuously and periodically with the change of the rotation angle. From the perspective of an external observer, this physical optical change manifests as flowing light and sparkling on the surface of the decoration 403, as well as dynamic light spots projected on the surrounding environment (such as the ceiling or wall). This design utilizes the principle of relative motion to achieve rich optical dynamic effects without setting complex conductive structures on the rotating body.

In this embodiment, the second gear 306 and the transmission member 314 are integrally formed. It is understandable that, in some embodiments, the second gear 306 can also be fixedly connected to the transmission member 314 by other means such as welding, adhering, riveting, screwing, etc., but is not limited thereto. In this embodiment, the mounting base 313 and the transmission member 314 are set opposite to each other. The mounting base 313 comprises a first screw hole (not shown in the figure), and the transmission member 314 is provided with a second screw hole (not shown in the figure) at a corresponding position. The mounting base 313 is fixedly connected to the transmission member 314 by a screw (not shown in the figure) passing through the first screw hole and the second screw hole.

In another embodiment, the mounting base 313 comprises a buckle 303. The buckle 303 is set on the side of the flange 302 facing the transmission member 314. The transmission member 314 is provided with a clamping opening 309 corresponding to the position of the buckle 303. The mounting base 313 is clamped to the clamping opening 309 of the transmission member 314 via the buckle 303. It is understandable that, in some embodiments, the mounting base 313 can also be fixedly connected to the transmission member 314 by other means such as welding, adhering, riveting, screwing, etc., but is not limited thereto.

In this embodiment, the flange 302 is further provided with a mounting hole 310, and the decoration 403 is detachably connected to the mounting base 313 through the mounting hole 310; in this way, the user can match and install different decorations 403 according to personal needs.

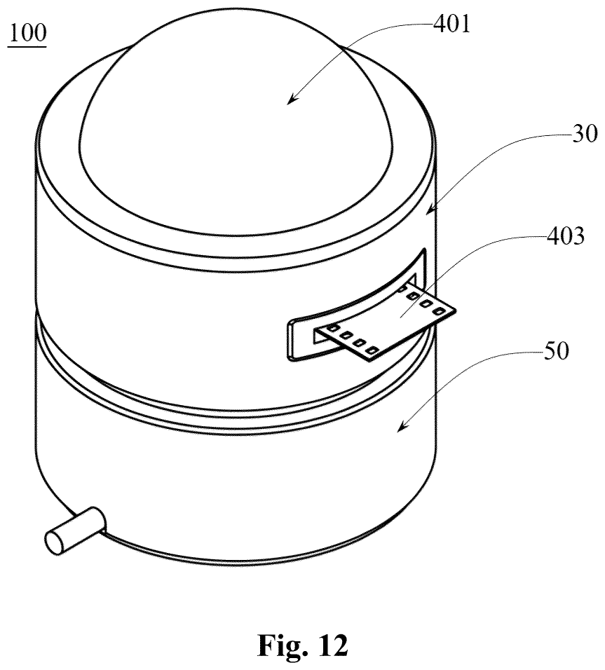

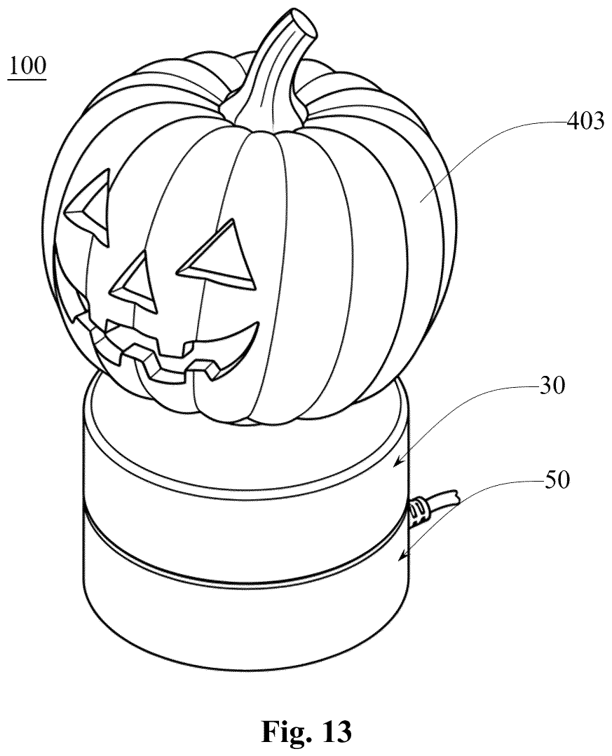

Referring to FIG. 12, in some embodiments, the rotatable light-emitting ornament 100 is applied to the field of commercial display, serving as a dynamic Logo projector. In this embodiment, the mounting base 313 of the rotator 30 is provided with a film slot as part of the decoration 403. Merchants can insert a heat-resistant film (decoration 403) printed with a brand Logo or promotional information into the slot. The light source 401 cooperates with a wide-angle lens group to pass light through the rotating film. When the device is started, the rotating brand Logo is projected onto the store floor, wall, or window glass.

Referring to FIG. 13, in some embodiments, to expand the seasonal market, by utilizing the universal drive platform of the present application (i.e., the universal mounting component 50 and drive 20), the decoration 403 is replaced with a Halloween theme. Specifically, the decoration 403 is constructed as a hollow pumpkin head shape. The rotator 30 drives the pumpkin head to rotate. The light source 401 uses flickering orange or purple LEDs. Furthermore, the rotation axis of the rotator 30 can be designed as an eccentric structure, causing the pumpkin head to produce a “shaking” or “nodding” grotesque action when rotating, creating a unique festive horror atmosphere in combination with ghost sounds played by an internal sound effect module.

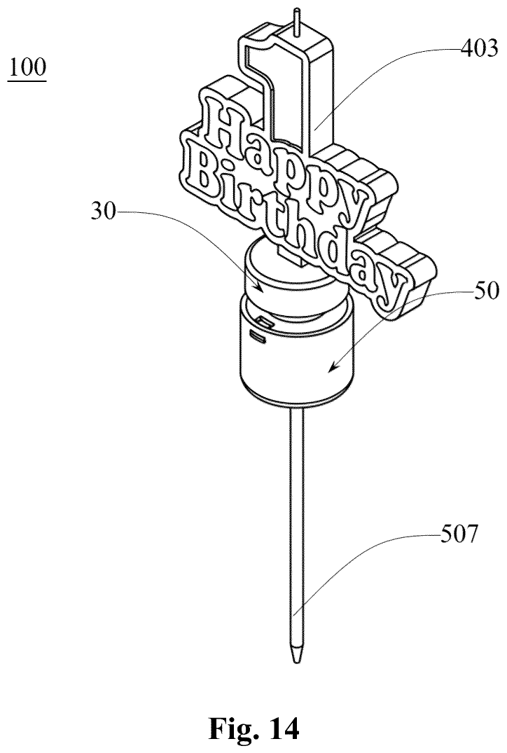

Referring to FIG. 14, in some embodiments, the rotatable light-emitting ornament 100 is constructed as a food-grade cake decoration insert through miniaturized design. In this form, the housing 501 of the mounting component 50 uses food-grade ABS material, and the support 507 is designed as a slender pin for insertion into a cake body. Power 10 uses a micro button battery for the power supply. The decoration 403 is designed as “Happy Birthday” wording or a number candle shape. After startup, the decoration 403 rotates slowly on top of the cake and emits soft light, and can even play a happy birthday song in cooperation with a music module.

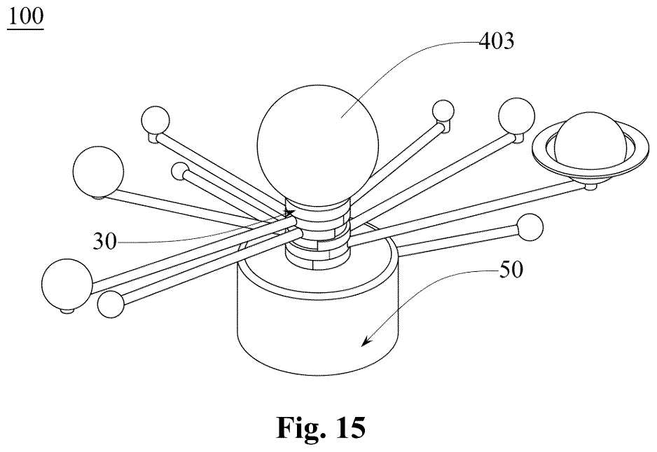

Referring to FIG. 15, in some embodiments, the rotatable light-emitting ornament 100 is designed as a children's educational toy, such as a “Solar System Model”. Specifically, the center of the mounting component 50 serves as the sun (with built-in light source 401), remaining stationary. The rotator 30 extends multiple supporting arms of different lengths as part of the decoration 403, and the ends of the supporting arms are respectively connected to spheres representing major planets. The drive 20 drives the rotator 30 to rotate, thereby simulating planetary revolution. The light source 401 not only illuminates the central “sun” but also illuminates each “planet” through light pipes.

It should be noted that the embodiments shown in FIG. 11 to FIG. 15 are all based on the universal rotation drive architecture described in the present application (i.e., the basic unit containing the mounting component 50, drive 20, and rotator 30), which can be realized only by replacing different decorations 403 and/or supports 507. This modular design avoids developing molds separately for each application scenario, reflecting multiple embodiments under a single inventive concept of the present application, rather than independent, unrelated inventions.

Optionally, the flange 302 is further provided with a first fastener 311, and the decoration 403 is detachably connected to the mounting base 313 through the first fastener 311; in this way, the user can match and install different decorations 403 more flexibly according to personal needs and the installation requirements of the decoration 403. Optionally, the first fastener 311 is a threaded foot.

In this embodiment, the transmission member 314 and the mounting component 50 are set opposite to each other. The transmission member 314 further comprises a first annular wall 304. The first annular wall 304 is set at the periphery of the transmission member 314. The mounting component 50 comprises a second base 502. A second annular wall 508 is arranged on the surface of the second base 502 facing the transmission member 314 corresponding to the first annular wall 304. The first annular wall 304 is slidably connected to the second annular wall 508 so that the rotator 30 is rotatably connected to the mounting component 50.

In this embodiment, the rotation center of the second gear 306 is concentric with the rotation center of the transmission member 314. The mounting component 50 further comprises a second fastener 503 corresponding to the rotation center of the second gear 306, and a first bearing 511 sleeved on the periphery of the second fastener 503. The first bearing 511 is provided close to the surface of the second base 502, facing the transmission member 314. The inner wall of the second gear 306 surrounds the second fastener 503 and the first bearing 511. The inner wall of the second gear 306 is slidably connected to the first bearing 511 so that the second gear 306 is capable of rotating around the second fastener 503, thereby making the rotator 30 rotatably connected to the mounting component 50. In this embodiment, the second fastener 503 is cylindrical.

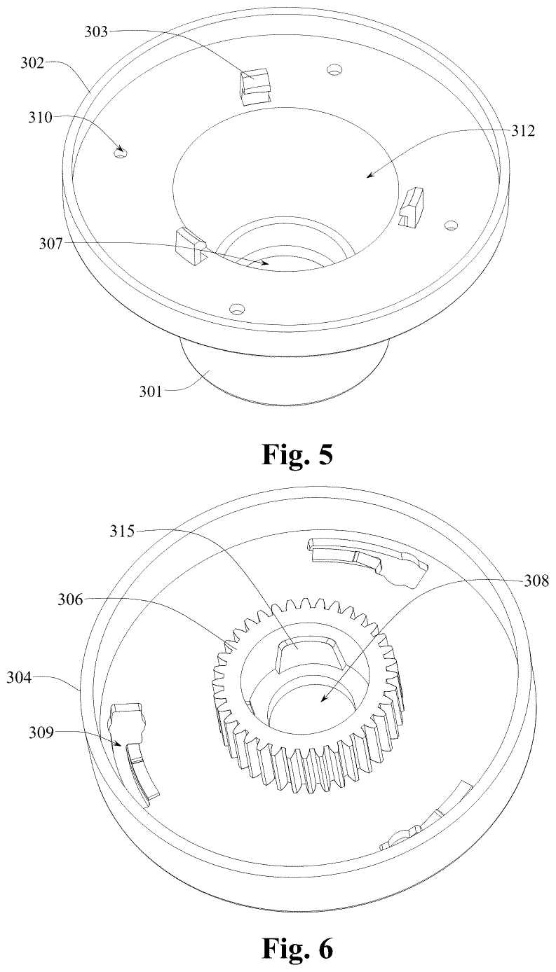

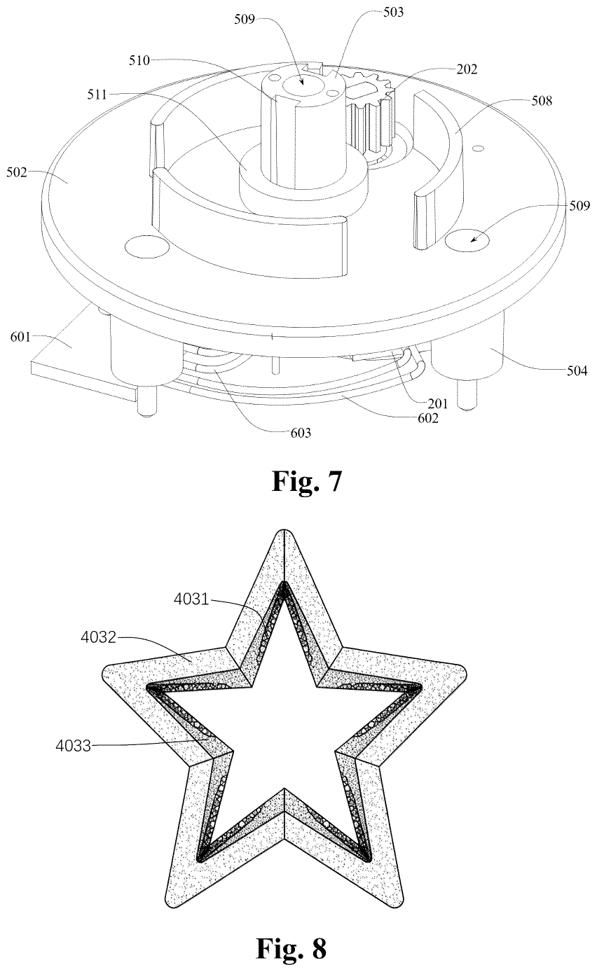

Optionally, referring to FIG. 6, the transmission member 314 comprises a second opening 308. The inner wall of the second opening 308 has a convex block 315. The convex block 315 is located on the side of the first bearing 511 facing away from the second base 502. The convex block 315 is arranged on the inner wall of the second opening 308. The first bearing 511 is located between the convex block 315 and the second base 502. When the transmission member 314 is installed on the second base 502, the first bearing 511 is stuck on the surface of the second base 502 by the convex block 315.

Optionally, the light source 401 is an LED bead. It is understandable that, in some embodiments, the light source 401 can also be of other types, such as a filament. In this embodiment, the decoration 403 is a transparent or semi-transparent object. The shape of the decoration 403 is star-shaped, such as a five-pointed star, a six-pointed star, and the like, but is not limited thereto. It is understandable that, in some embodiments, the shape of the decoration 403 can also be other shapes, such as an angel shape, a mushroom shape, and the like.

In some embodiments, the decoration 403 is constructed as a simulation tree structure. Specifically, the outer wall surface of the base 5071 is cylindrical to simulate a tree stump shape. The decoration 403 includes a simulation tree trunk extending upward and a plurality of simulation branches diverging outward from the simulation tree trunk. The outer surface of the simulation branches is covered with a reflective layer (such as silver reflective tape). Thus, the light source 401 includes a plurality of point light emitters (such as LED beads) distributed at the ends of the simulation branches, forming a spatial light-emitting array. Furthermore, in this embodiment of the simulation tree structure, the light source 401 can emit warm gold light, cool white light, pink light, or colored (RGB) light according to a preset configuration. The controller 60 is configured to control the light source 401 to execute a static steady on, breathing gradient, or flickering light-emitting sequence. When the motor 201 drives the decoration 403 to rotate relative to the base 5071, the simulation branches and the light source 401 at their ends rotate accordingly, cooperating with the reflection effect of the reflective layer to create a visual effect of flowing light and shadow.

In this embodiment, the light source 401 is fixedly connected to the mounting component 50. The mounting base 313 comprises a first opening 307. One side of the first opening 307 faces the decoration 403, and the other side of the first opening 307 faces the light source 401. The light emitted by the light source 401 passes through the first opening 307 to illuminate the decoration 403.

It is understandable that, in some embodiments, referring to FIG. 10, to balance the dual needs of illuminating the decorative body and environmental projection, the light source 401 of the lighting component 40 is constructed as a composite light source containing a first lighting unit 4011 and a second lighting unit 4012. The optical axis of the first lighting unit 4011 (e.g., a central spotlight type LED) is arranged along the vertical direction, and its emitted light mainly illuminates the top of the decoration 403. The second lighting unit 4012 (e.g., a lateral light-emitting LED ring or RGB bead array) is arranged around the first lighting unit, and its light primarily illuminates the side wall of the decoration 403. The side wall of the decoration 403 is made of diffuse reflection material or frosted semi-transparent material, used to uniformly scatter the light of the second lighting unit 4012, such that the decoration 403 as a whole presents a soft “glow” effect.

In this embodiment, the mounting base 313 further comprises a first cavity 312. The first opening 307 is in communication with the first cavity 312. The light source 401 is contained in the first cavity 312.

In this embodiment, the lighting component 40 further comprises a first base 402. The first base 402 is fixedly connected to the second fastener 503. The first base 402 is contained in the first cavity 312. The light source 401 is provided between the first base 402 and the first opening 307. The first base 402 is provided between the light source 401 and the second fastener 503. The light source 401 is fixedly connected to the first base 402, and the first base 402 is fixedly connected to the second fastener 503.

In this embodiment, the transmission member 314 is provided with a first annular protrusion 305 on the side facing the mounting base 313. The first base 402 is provided with a second annular protrusion 404 on the side facing the transmission member 314. The first annular protrusion 305 surrounds the outer side of the second annular protrusion 404 to limit the position of the first base 402. The second fastener 503 extends from the surface of the second base 502 facing the transmission member 314, passes through the inner wall of the second gear 306 to form a hole, protrudes from the first annular protrusion 305, and abuts against the surface of the first base 402 facing the second fastener 503. The first base 402 is provided with a second threaded hole corresponding to the position of the second fastener 503 on the surface facing the second fastener 503. The second fastener 503 is provided with a first threaded hole 509 corresponding to the position of the second threaded hole. The first base 402 is fixedly connected to the second fastener 503 by screws.

The embodiments described above are merely examples of the present disclosure, and should not be used to limit the scope of the present disclosure, which may have various modifications and variations made by specialists in the field. Any modification, equivalent replacement or improvement made within the spirits and principles of the present disclosure shall be included in the scope of protection of the present disclosure.

What is claimed is:

1. A rotatable light-emitting ornament, comprising:
a mounting component, wherein the mounting component includes a housing;
a drive disposed in the housing; a rotator rotatably supported by the mounting component, wherein the drive is connected to the rotator to drive the rotator to rotate relative to the mounting component; and
a lighting component, comprising a light-transmitting decoration and a light source disposed on the mounting component or the rotator;
wherein the rotator includes a transmission member configured to receive a driving force from the drive, and a mounting base fixedly connected to the transmission member, wherein the mounting base and the transmission member are independent components manufactured separately, and the mounting base is configured to carry the light-transmitting decoration and drive the light-transmitting decoration to rotate synchronously around a rotation axis of the rotator; and wherein the light source is configured to illuminate the light-transmitting decoration.

2. The rotatable light-emitting ornament according to claim 1, wherein the mounting component further includes a second fastener fixedly connected to the housing; the rotator is configured as an annular structure, and the rotator is sleeved on a periphery of the second fastener and is rotatable around the second fastener; the light source is installed on the second fastener; and the second fastener is provided with a passage for a wire to pass through.

3. The rotatable light-emitting ornament according to claim 2, wherein the transmission member is rotatably connected to the second fastener via a first bearing; the drive includes a motor and a first gear, and the transmission member includes a second gear engaged with the first gear.

4. The rotatable light-emitting ornament according to claim 1, wherein the mounting base is provided with an elastic buckle structure, the transmission member is provided with a corresponding clamping opening, and the mounting base is detachably fixedly connected to the transmission member via the elastic buckle structure.

5. The rotatable light-emitting ornament according to claim 1, wherein a wall surface of the light-transmitting decoration is provided with a light-guiding texture, a prism refraction surface, or a bubble structure, and the light source illuminates the light-transmitting decoration from an interior of the light-transmitting decoration to produce a dynamic light and shadow effect when the light-transmitting decoration rotates.

6. The rotatable light-emitting ornament according to claim 1, wherein a bottom of the mounting component is connected to a support, and the support is selected from one of the following: a conical tubular structure for insertion into the top of a Christmas tree, a long rod for insertion into soil, or a base for placement on a flat surface.

7. The rotatable light-emitting ornament according to claim 1, wherein the light source is installed on the rotator or the mounting base to rotate together with the light-transmitting decoration; the rotatable light-emitting ornament further includes a power connected to the mounting component; a conductive slip ring assembly is provided between the mounting component and the rotator, and the light source is electrically connected to the power through the conductive slip ring assembly.

8. The rotatable light-emitting ornament according to claim 7, wherein the mounting component includes a second fastener fixedly connected to the housing, and the conductive slip ring assembly includes a stator slip ring disposed on the second fastener and a brush disposed on an inner side of the rotator and in contact with the stator slip ring.

9. The rotatable light-emitting ornament according to claim 1, wherein the light source includes a first lighting unit and a second lighting unit, an optical axis of the first lighting unit faces a top of the light-transmitting decoration, and an optical axis of the second lighting unit faces a side wall of the light-transmitting decoration.

10. The rotatable light-emitting ornament according to claim 1, wherein a bottom of the housing is provided with a third lighting unit, and the third lighting unit is configured to emit light in a direction away from the light-transmitting decoration to illuminate an area below the mounting component.
